(19) United States
(12) Patent Application Publication
(10) Pub. No.: US 2022/0161750 A1
(43) Pub. Date: May 26, 2022

(54) CHILD SAFETY SYSTEM ANCHOR USE AND ANCHOR TENSION SENSING LOGIC

(71) Applicant: GM Global Technology Operations LLC, Detroit, MI (US)

(72) Inventors: Scott D. Thomas, Novi, MI (US); Suzanne L. Johansson, Rochester Hills, MI (US)

(21) Appl. No.: 16/953,727

(22) Filed: Nov. 20, 2020

(51) Int. Cl. B60R 21/015

(52) U.S. Cl. CPC B60R 21/01556; B60R 21/01546; B60R 2021/006; B60R 21/01566; B60R 21/0155

(57) ABSTRACT

A system and method for determining when a child safety system is present in a passenger seat in a vehicle and restrained, including at least one of: a) two lower anchors each including a lower anchor sensor, or b) an upper anchor including an upper anchor sensor; an occupancy sensor; a seatbelt buckle sensor; a microprocessor control system in communication with at least one of the sensors. The microprocessor control system includes executable code to: provisionally determine whether the child safety system is detected in the passenger seat; determine whether at least one of: a) a strap is connected to each lower anchor and b) a tether is connected to the upper anchor; determine whether the seatbelt is buckled; and verify the presence of a child safety system in the passenger seat. Executable code can also be included to detect strap and tether tension.

### INTRODUCTION

The present disclosure relates to sensing logic for detecting lower and upper anchor use, including a system and method for detecting lower and upper anchor use and tension applied to the lower and upper anchors.

A number of safety mechanisms have been incorporated into vehicles for preventing or reducing injury in case of a vehicle crash. Seatbelts, for example, assist in restraining passengers. Airbags, used in combination with seatbelts, provide cushioning and restraint of occupants. Child restraint systems (CRS) and belt positioning booster seats position a child in a passenger seat and may be used in conjunction with seatbelts, with lower and upper anchors, or with a combination thereof. In addition, various warning indicators may warn the occupants if an occupant is detected but certain parameters have not been met, such as an unbuckled seatbelt.

It has been found, however, that some safety systems may be redundant or improperly used. For example, if frontal airbags are present in a passenger seat in which a child safety system is present, deployment of airbags generates forces that may be too high for children secured in a child restraint system or for children below a certain size and weight. Systems have been developed to manually and automatically deactivate selected airbags associated with a given passenger seat where a child may be sitting. For example, a weight sensing system may be used to automatically deactivate an airbag by sensing and measuring the weight of an occupant in a given seat. If the weight is less than a threshold, selected airbag(s) associated with that seat is deactivated. In some situations, however, the combination of a child and a child restraint system may result in a weight measurement that is above the threshold for deactivating the airbags associated with that seat. In such a situation, without manual deactivation, selected airbags may deploy even though a child is present in the seat.

In addition, some manufacturers and countries specify that a CRS should be attached with only one type of restraint, either the seatbelt or the LATCH system. Some other countries and some other manufacturers accept using both types of restraints simultaneously.

Thus, while current seatbelt systems achieve their intended purpose, there is room for the development of new and improved systems and methods for sensing lower and upper anchor use and tension applied to the anchors associated with the passenger seats in a vehicle. In addition, new and improved systems and methods should provide a warning to the vehicle occupant or take an appropriate ride action if needed, such as when a child restraint system or seat-belt positioning booster seat is not properly secured to a passenger seat.

### SUMMARY

According to several aspects of the present disclosure, a system for determining when a child safety system is present in a passenger seat in a vehicle includes at least one of: a) two lower anchors each including a lower anchor sensor for sensing a presence of a strap connected to each lower anchor, or b) an upper anchor including an upper anchor sensor for sensing a presence of a tether connected to the upper anchor. The system further includes an occupancy sensor for provisionally sensing a child safety system present in the passenger seat. The system yet further includes a seatbelt buckle sensor for sensing a presence of a latch plate in the seatbelt buckle when the latch plate is connected to a seatbelt. The system also includes a microprocessor control system in communication with at least one of the lower anchor sensors, the upper anchor sensor, the occupancy sensor, and the seatbelt buckle sensor, wherein the microprocessor control system includes executable code to: provisionally determine whether the child safety system is detected in the passenger seat; determine whether at least one of: a) the straps are connected to each lower anchor and b) the tether is connected to the upper anchor; determine whether the seatbelt is buckled; and verify the presence of the child safety system in the passenger seat.

In further aspects, the microprocessor control system further includes executable code to determine if a correct tension is applied to at least one of: a) the lower anchors and b) the upper anchor.

In additional aspects, the system includes a seatbelt payout sensor for sensing a seatbelt payout length in communication with the microprocessor control system, and wherein the microprocessor control system further includes executable code to: compare the seatbelt payout length to a first seatbelt payout length threshold.

In further aspects, the microprocessor control system further comprises executable code to: issue at least one of a message and a ride action when a) the seatbelt is not buckled, b) the child safety system is provisionally detected in the passenger seat, and c) the strap is not connected to at least one of the lower anchors.

In further aspects, the microprocessor control system further comprises executable code to: issue at least one of a message and a ride action when a) the seatbelt is not buckled, b) the child safety system is provisionally detected in the passenger seat, c) the tether is connected to the upper anchor, and d) the strap is not connected to at least one of the lower anchors.

In further aspects, the microprocessor control system further comprises executable code to: issue at least one of a message and a ride action when a) the seatbelt is not buckled, b) the child safety system is provisionally detected in the passenger seat, c) the straps are connected to the lower anchors and d) the tether is not connected to the upper anchor.

In further aspects, the microprocessor control system further comprises executable code to: issue at least one of a message and a ride action when a) the seatbelt is buckled, b) the child safety system is provisionally detected in the passenger seat, and c) the tether is not connected to the upper anchor.

In further aspects, the microprocessor control system further comprises executable code to: issue at least one of a message and a ride action when a) the seatbelt is buckled, b) the child safety system is provisionally detected in the passenger seat, c) the strap is connected to the lower anchors, and d) the tether is connected to the upper anchor.

In further aspects, the microprocessor control system further comprises executable code to: determine whether to disable a restraint associated with the passenger seat, wherein the restraint comprises an airbag associated with the passenger seat and the microprocessor control system includes executable code to: disable deployment of at least one airbag when a child safety system is verified in the passenger seat.

According to several aspects of the present disclosure, a method for detecting when a child safety system is present in a passenger seat in a vehicle includes sensing at least one of: a) a presence or absence of a strap connected to at least one of two lower anchors associated with a passenger seat and b) a presence or absence of a tether connected to an upper anchor. The method further includes determining at least one of a) whether the strap is connected or not connected to at least one of the two lower anchors and b) whether the tether is connected or not connected to the upper anchor. The method also includes provisionally sensing a presence or absence of a child safety system in the passenger seat. The method yet further includes provisionally determining whether the child safety system is in or absent from the passenger seat. The method additionally includes sensing a presence or absence of a latch plate in a seatbelt buckle, wherein the latch plate is connected to a seatbelt.

In further aspects, the method includes determining if a correct tension is applied to at least one of: a) the lower anchors and b) the upper anchor.

In further aspects, the correct tension is determined to be present when at least one of the following occurs: a) measured tension is above a predetermined tension threshold, b) measured tension is within a given a predetermined threshold range, and c) measured tension for both lower anchor sensors is applied within a predetermined short duration time window if loading characteristics on the lower anchor sensors indicate that rigid straps are present.

In further aspects, the method includes sensing a seatbelt payout length and comparing the seatbelt payout length to a first seatbelt payout length threshold.

In further aspects, the method includes issuing at least one of a message and a ride action when a) the seatbelt is not buckled, b) the child safety system is provisionally detected in the passenger seat, and c) the strap is not connected to at least one of the lower anchors.

In further aspects, the method includes issuing at least one of a message and a ride action when a) the seatbelt is not buckled, b) the child safety system is provisionally detected in the passenger seat, c) the tether is connected to the upper anchor, and d) the strap is not connected to at least one of the lower anchors.

In further aspects, the method includes issuing at least one of a message and a ride action when a) the seatbelt is not buckled, b) the child safety system is provisionally detected in the passenger seat, c) the strap is connected to the lower anchors, and d) the tether is not connected to the upper anchor.

In further aspects, the method includes issuing at least one of a message and a ride action when the seatbelt is buckled, the child safety system is provisionally detected in the passenger seat, the tether is not connected to the upper anchor.

In further aspects, the method includes issuing at least one of a message, a ride action, or no action when a) the seatbelt is buckled, b) the child safety system is provisionally detected in the passenger seat, c) the strap is connected to both of the lower anchors and d) the tether is connected to the upper anchor.

In further aspects, the method includes disabling deployment of at least one airbag when the child safety system is verified in the passenger seat.

In further aspects, the method includes determining the seatbelt is buckled; making a first determination if something is present in the passenger seat; and after a period of time making a second determination if something is present in the passenger seat.

### BRIEF DESCRIPTION OF THE DRAWINGS

The drawings described herein are for illustration purposes only and are not intended to limit the scope of the present disclosure in any way.

FIG. 1A is a schematic diagram of a child restraint seat positioned in a passenger seat according to an exemplary embodiment;

FIG. 1B is an illustration of a child restraint seat according to an exemplary embodiment;

FIG. 2 is an illustration of the interior of a vehicle according to an exemplary embodiment;

FIG. 3 is a schematic of various restraint systems associated with a passenger seat according to an exemplary embodiment;

FIG. 4 is a flow chart of a process for determining whether a child restraint seat is attached according to an exemplary embodiment;

FIG. 5 is a flow chart of a method of determining whether a child restraint seat is attached according to an exemplary embodiment;

FIG. 6 is a flow chart of a method of determining whether a child restraint seat is attached and properly tensioned according to an exemplary embodiment;

FIG. 7 is a flow chart of a method of determining whether a child restraint seat is attached and properly tensioned according to an exemplary embodiment;

FIG. 8 is a flow chart of a method of determining whether an occupant is present in a child restraint seat according to an exemplary embodiment; and

### DETAILED DESCRIPTION

The following description is merely exemplary in nature and is not intended to limit the present disclosure, application, or uses. The present disclosure relates to lower and upper anchor use and, optionally, tension detection sensing logic, including a system and method for detecting lower and upper anchor use and the tension applied to the anchors. In a number of aspects, the system and method include a number of sensors associated with a passenger seat, including sensors pertaining to a LATCH (Lower Anchor and Tether for CHildren) system and sensors pertaining to a passenger seat safety restraint system. The Lower Anchor and Tether for Children system has various names depending on region: Lower Anchors and Tethers for CHildren (LATCH) is generally used in the United States, LUAS (Lower Universal Anchorage System) or CANFIX is generally used in Canada, or Isofix per the International Organization for Standardization standard ISO13216 is generally used in other parts of the world. For the purpose of this document, Lower Anchor and Tether for Children is used herein to collectively refer to the various anchor systems.

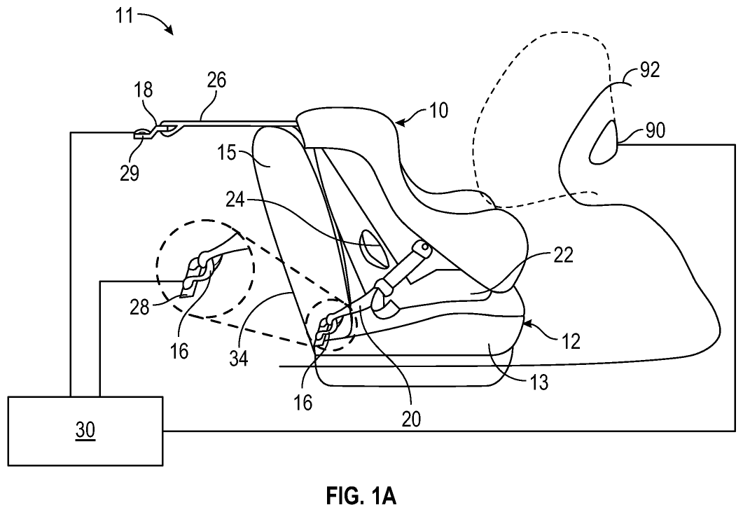

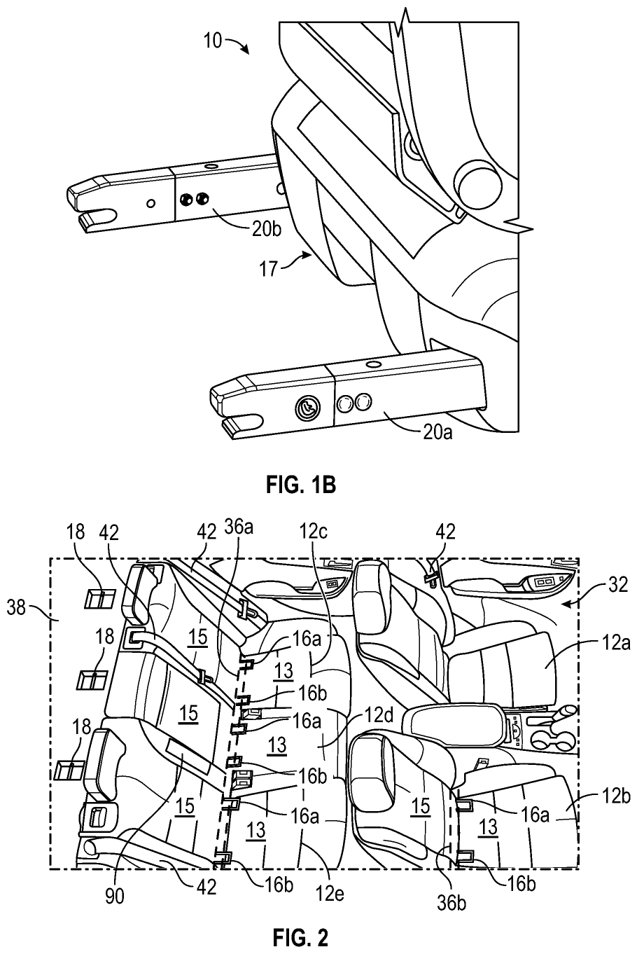

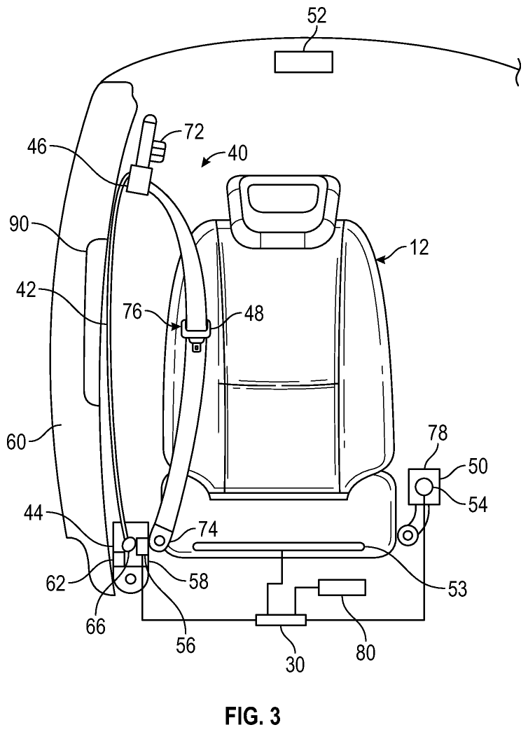

Referring to FIG. 1A and FIG. 1B, a child safety system 10 and LATCH system 11 are illustrated in accordance with several aspects of this disclosure. Child safety systems 10 include, for example, child restraint seats that include a harness, or seatbelt positioning booster seats. When in use, a child safety system (CSS) 10 is secured to a passenger seat 12 in a motor vehicle via anchors 16, 18 associated with the given passenger seat 12, also referred to as the LATCH system 11. In the forward-facing position, the child safety system 10 rests on the seat base 13 and seat back 15 of a passenger seat 12. The LATCH system 11 includes two lower anchors 16 (only one is illustrated), positioned between the seat base 13 and the seat back 15 of the passenger seat 12, and an upper anchor 18, which is located behind the passenger seat 12. One or more straps 20 are provided to couple the child safety system 10 to the lower anchors 16. As illustrated, a strap 20 is connected to each side 22 of the child safety system 10. In alternative aspects, a single strap 20 may be passed through the strap routing path 24 provided in the child safety system 10 located as shown in FIG. 1A or in a different location. Note that the term strap in this document can refer to a flexible piece of material that can be tensioned. In alternative aspects, such as illustrated in FIG. 1B, a strap also refers herein to a rigid arm 20a, 20b extending from the base 17 of the child safety system 10 that, in aspects, can be tensioned. The illustrated child safety system 10 also includes a tether 26. The tether 26 connects the upper portion of the child safety system 10 to the upper anchor 18, which couples the top of the child safety system 10 to the top of the passenger seat 12 or nearby vehicle structure. In the rear facing position (not illustrated), the lower anchors 16 are used to secure the child safety system 10 into the passenger seat 12. The tether 26 and upper anchor 18 may also be used in the rear facing position. In alternative aspects, the child safety system 10 may be secured to the passenger seat 12 using the seatbelt 42 associated with the passenger seat (see FIG. 2) alone, or in combination with either the strap(s) 20, tether 26 or both the strap(s) 20 and tether 26 of the LATCH system 11.

In aspects, the vehicle side lower anchors 16 and the upper anchor 18 are rigid and do not move or change in shape. In alternative aspects, the upper anchor 18 may be flexible or the tether's 26 path to the upper anchor 18 could route the tether 26 around a portion of the vehicle seat back 15 that could be partially flexible. In further aspects, lower anchors 16 are used with the upper anchor 18; however, when child safety systems are installed using the seatbelt 42, it may require connection of only the top tether 26 to the upper anchor 18, if available. In further aspects, the flexible lower anchor straps 20 and tether 26 can be tensioned and a level of tension is sensed by sensors 28, 29. Likewise, child safety systems 10 with rigid lower straps 20 are on a sliding assembly at the rear of the base 17 of the child safety system 10. When the sliding assembly of the rigid lower straps 20 is extended to attach the child safety system 10 to the lower anchors 16, the user to pushes the child safety system 10 into the seat back 15 until the sliding assembly of the rigid lower straps 20 is retracted and locked, reducing all fore/aft motion. The use of the straps 20 will remove most of the cross-car motion of the child safety system 10 and will produce some tension that can be assessed on the vehicle lower anchors 16.

A lower anchor sensor 28 is associated with each lower anchor 16 and an upper anchor sensor 29 is associated with the upper anchor 18. When the straps 20 are connected to the lower anchors 16a, 16b, each lower anchor sensor 28 transmits a control signal to a microprocessor control system (MCS) 30 indicating each strap 20a, 20b has been connected to the respective lower anchor 16a, 16b. If nothing is attached to the lower anchors 16a, 16b, each lower anchor sensor 28 may transmit a different control signal to a microprocessor control system (MCS) 30 indicating that nothing has been connected to the respective lower anchor 16a, 16b. If tension sensing is also used, each lower anchor sensor 28 transmits a control signal to the MCS 30 indicating that the straps 20 have been tensioned above a predetermined force level. Similarly, when the tether 26 is connected to the upper anchor 18, the upper anchor sensor 29 transmits a control signal to the microprocessor control system 30 indicating the tether 26 has been connected to the upper anchor 18. Upper anchor sensor 29 may also transmit a different control signal to the MCS 30 indicating that nothing has been connected to upper anchor 18. If tension sensing is also used, the upper anchor sensor 29 transmits a control signal to the MCS 30 indicating that the tether 26 has been tensioned above a predetermined force level. The microprocessor control system 30 includes a control algorithm that receives the control signal from the anchor sensors 28, 29 and determines whether the straps 20, tether 26, or both the straps 20 and tether 26 are connected to the lower anchors 16 and upper anchor 18 and optionally tensioned above a predetermined force level to the lower anchors 16 and upper anchor 18. The microprocessor control system 30, in aspects, includes one or more processors and memory modules for storing and implementing the control algorithm.

While an infant or convertible child safety system 10 is illustrated, the child safety system 10 may alternatively be an infant only seat with a base, high back booster seat, backless booster seat, or a variation thereof depending on at least one of the age, weight and height of the child. It should, therefore, be appreciated that depending on the configuration of the child safety system 10 and user preference, at least of the following: two lower anchors 16, an upper anchor 18, and a seatbelt 42 (see FIG. 2), may be used to secure the child safety system 10 to the passenger seat 12. There are other types of child safety systems 10 including: a convertible child restraint seat containing an integral five point harness that can be forward and rearward facing, a rear facing only child restraint seat containing an integral harness with or without base, a combination seat which is a forward facing five point harness child restraint seat that can transition to a booster seat, only a booster seat (either with a high back seating surface or without a back seating surface), or all-in-one child restraints that offer configurations for more than two stages of child development, such as an infant through booster seat. For booster seat options, the vehicle seatbelt 42 is used to restrain the child and, usually, the booster seat as well. Some booster seat designs can use LATCH to keep the booster in position while when the child is seated and belted with the vehicle seatbelt 42. Not all booster seats that offer LATCH require LATCH to be used while the child is seated on the booster seat, however, the use of LATCH allows the booster to remain connected to the vehicle lower anchors 16 when the child is not present. There are also transverse child bed restraints where the child is positioned lying down, usually laterally across the vehicle seat and the child uses a five-point harness system within the transverse child bed. These child bed child safety systems can be attached to the vehicle by a seatbelt 42 and also, sometimes, with a LATCH attachment approach.

FIG. 2 illustrates the positioning of lower anchors 16a, 16b and upper anchors 18 in a vehicle interior 32 relative to the passenger seats 12a, 12b, 12c, 12d, 12e in accordance with several aspects of this disclosure. The passenger seats 12a, 12b, 12c, 12d, 12e include a driver seat 12a and front passenger seat 12b and three rear passenger seats 12c, 12d, 12e. In the aspect illustrated, a set of lower anchors 16a, 16b are associated with the passenger seats 12b, 12c, 12d, 12e. The lower anchors 16a, 16b are connected to a cross member 36, such as a crossbeam 36a, that forms a part of the vehicle frame, or a cross bar 36b that is integrated into a passenger seat 12b. Further, an upper anchor 18 is associated with each rear passenger seat 12c, 12d, 12e and located in the rear deck 38. An upper anchor 18 may also be associated with the front passenger seat 12b and placed at either in the back surface 34 (see FIG. 1) of the passenger seat 12 or integrated into the vehicle roof or floor. Similarly, if the rear passenger seats 12c, 12d, 12e are captains' chairs or if the rear deck 38 is not present, the upper anchor 18 may be placed at either the back 34 of the passenger seats 12c, 12d, 12e, integrated into the roof or in the floor (not illustrated). For a tether re-router system, such as a truck with limited space for anchorages, the anchorage would reside on the seat back of the adjacent seat to the child safety system 10 being installed. For a fully autonomous vehicle, similar anchor arrangements can be used for all seating positions no matter which direction the vehicle seat faces or in what row/position the seat is located.

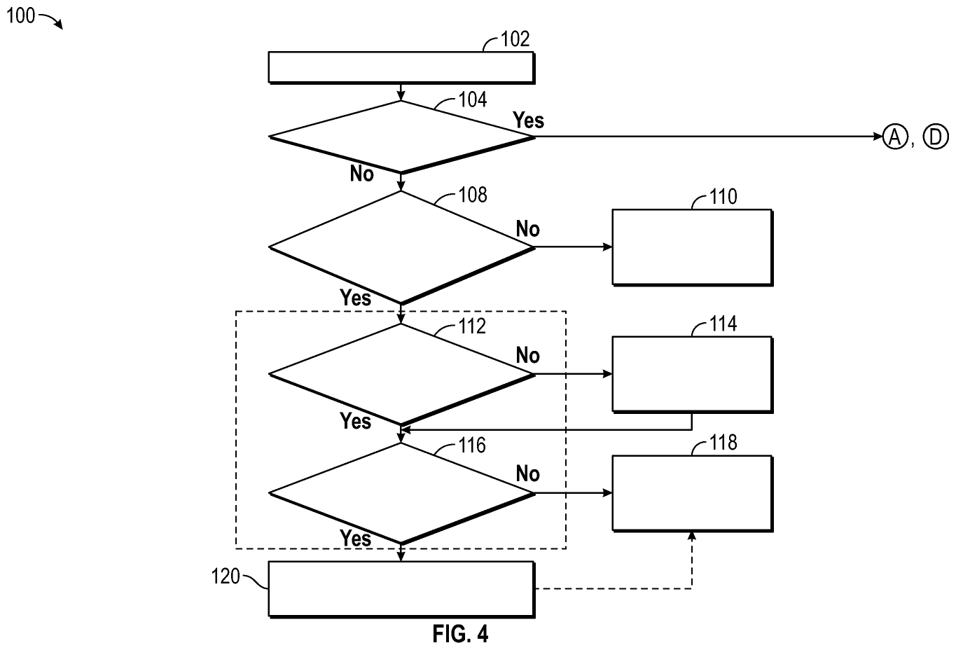

As noted above and illustrated in FIG. 3, each passenger seat 12 includes a safety restraint system 40, which forms a part of the system and method for detecting lower anchor 16 and upper anchor 18 use in accordance with several aspects of this disclosure. An aspect of the safety restraint system 40 includes a seatbelt 42, a seatbelt retractor 44 that may, in aspects, be an automatic locking retractor (ALR), a guide loop 46, a latch plate 48, and a buckle 50. The safety restraint system 40 also includes a number of sensors, including one or more occupancy sensors 52 (located remote from the seat), 53 (located at any location within the seat or seat to floor attachment), a seatbelt buckle sensor 54, a seatbelt payout sensor 56, and an automatic locking retractor sensor 58 if the seatbelt retractor 44 includes an automatic locking retractor.

The seatbelt retractor 44 is fixed to a structural member of the motor vehicle adjacent to the passenger seat 12. For example, the seatbelt retractor 44 is affixed to the base of the B-pillar 60 or to a cross member 36. The seatbelt retractor 44 includes a frame 62, which rotatably supports a retractor spool 66 for free rotation in the seatbelt retractor 44. Alternatively, the seatbelt retractor could be attached to the passenger seat 12.

A coil spring (not shown) is operatively attached to the seatbelt retractor 44 at one end of the spring and to the retractor spool 66 at another end of the spring to retract the seatbelt 42 into the seatbelt retractor 44. The seatbelt 42 is at least partially wound around the retractor spool 66 for storing the seatbelt 42 in the seatbelt retractor 44 when the safety restraint system 40 is not in use. When the safety restraint system 40 is in use, the seatbelt 42 is unwound from the retractor spool 66 and pulled out of the seatbelt retractor 44 by a vehicle occupant.

The seatbelt payout sensor 56 is in communication with the retractor spool 66. The seatbelt payout sensor 56 is configured to sense the rotation of the retractor spool 66 and includes, for example, a potentiometer or a rotary sensor. The microprocessor control system 30 receives the retractor spool rotation signal from the seatbelt payout sensor 56 and is configured to determine the length of the seatbelt payout, i.e., the seatbelt payout length, from the rotation of the retractor spool 66 of the seatbelt retractor 44. The seatbelt payout sensor 56 may also be used to detect the engagement or disengagement of the automatic locking mechanism in the automatic locking retractor. In aspects, the microprocessor control system compares the seatbelt payout length with at least a first seatbelt payout length threshold, which may be e.g., a previously stored seatbelt payout length measured by the seatbelt payout sensor 56 or stored value in the microprocessor control system

Guide loop 46 is fixedly secured to the motor vehicle, generally, towards the top of the B-pillar 60 of the motor vehicle. As an alternative, it could be also attached to the passenger seat 12. An optional adjustment button 72 and adjustment slot (not shown) are provided between the guide loop mounting structure on the vehicle and the guide loop 46 that receives and slidably engages the seatbelt 42. This slot enables the guide loop 46 to be adjusted up or down in a track (not shown) to improve seatbelt routing geometry. The seatbelt 42 generally extends from the seatbelt retractor 44 up and along the B-pillar 60 and is threaded or routed through guide loop 46 where the seatbelt 42 is directed down toward the base of the passenger seat 12 and is secured at a terminal end 74 to a structural member of the motor vehicle or passenger seat 12, such as to a cross member 36 (not illustrated) or to the B-pillar 60. In aspects, the guide loop 46 includes a guide loop position sensor 47, which measures the location of the guide loop 46 relative to the B-pillar 60 or to the passenger seat 12 if the guide loop can either rotate or translate to different positions. In aspects, the guide loop 46 may be omitted, such as where a seatbelt 42 is located in a center passenger seat 12d.

The latch plate 48 has a slot 76 through which the seatbelt 42 is threaded to slidably engage the latch plate 48. The latch plate 48 is located on the seatbelt 42, generally, between the guide loop 46 and the terminal end 74 of the seatbelt 42. The buckle 50 is configured to releasably capture the latch plate 48. Typically, latch plate 48 is inserted into a buckle slot 78 in the buckle 50. After the latch plate 48 is fully inserted into the buckle slot 78, the latch plate 48 is locked in the buckle 50. A button (not illustrated) on the buckle 50 is depressed to release the latch plate 48 from the buckle 50.

A seatbelt buckle sensor 54 is provided in the seatbelt buckle 50. Seatbelt buckle sensor 54 is configured to sense the presence of the latch plate 48. Seatbelt buckle sensor 54 transmits a control signal to the microprocessor control system 30. The microprocessor control system 30 includes a control algorithm that receives the control signal from the seatbelt buckle sensor 54 and determines whether the latch plate 48 is present in the seatbelt buckle 50. That is, a determination is made whether the seatbelt 42 is buckled.

One or more occupancy sensors 52, 53 are provided to sense the presence of an occupant or to provisionally sense a child safety system 10 or other object in the passenger seat 12. Occupancy sensors 52, 53 may also be used to sense the seatbelt routing and possibly motions to attach child safety system 10 to LATCH or the LATCH attachments themselves. Occupancy sensor 52 is positioned adjacent to the passenger seat 12 and assesses occupant presence by image capturing or by measured changes in reflected electromagnetic energy emitted by an emitter, such as via one or more of cameras, RADARs, ultra-sonic sensors, infrared sensors, etc. Occupancy sensor 53 is disposed in the passenger seat 12 and assesses occupant presence via different means such as one or more pressure pads, weight pads, load cells, resistive pads, and biometric sensors. Each occupancy sensor 52, 53 transmits a control signal to the microprocessor control system (MCS) 30. In detecting different objects, occupancy sensors 52, 53 may have one or more detection thresholds (such as weight, general shape, location, etc.) to distinguish occupants from objects, detect the size of the occupant or object, detect the location of the occupant or object relative to the surface of the seat base 13 of the passenger seat 12 to detect seatbelt 42 routing, or to detect LATCH attachment.

Further, a seat position sensor 80 determines the position of a passenger seat 12 relative to a fixed point in the vehicle, such as a cross member 36, the B-pillar 60, or another reference point in the vehicle. The seat position sensor 80 transmits a control signal to the microprocessor control system (MCS) 30 that indicates the position of the passenger seat 12 relative to the fixed point in the vehicle, including alterations in at least one of 1) the height, 2) the seat back angle, 3) the seat base angle , and 4) fore-aft location.

Referring again to FIG. 1A, the safety restraint system 40 also includes one or more airbags 90 associated with the passenger seat 12. Airbags 90 are, generally, located in the dashboard 92 as illustrated in FIG. 1A, between passenger seats as illustrate in FIG. 2 (see in between passenger seats 12d and 12e), in the B-pillar 60 of the motor vehicle as illustrated in FIG. 3, in a vehicle roof (not shown), in a vehicle door (not shown) or in the outboard side or back side of a vehicle seat (not shown). The airbags 90 are connected to the microprocessor control system (MCS) 30. When the microprocessor control system (MCS) 30 determines an impact has occurred, such as when a vehicle decelerates with a force equal to hitting an object at a given speed (such as, for example, a speed of more than 25 kilometers per hour), the microprocessor control system (MCS) 30 deploys the airbags 90 as illustrated by the dotted line. The microprocessor control system (MCS) 30 sets whether or not the airbags 90 associated with a given passenger seat 12 is deployed in an accident. In aspects, the microprocessor control system (MCS) 30 sends a signal to certain airbag(s) 90, turning off or on these airbags 90 associated with a given passenger seat 12.

The present disclosure includes a plurality of algorithms and methods for determining the presence of a child safety system 10 in a passenger seat 12 as well as for processing by the microprocessor control system 30 of the control signals from the lower anchor sensors 28, the upper anchor sensor 29, the seatbelt buckle sensor 54, the occupancy sensors 52, 53, the seatbelt payout sensor 56, etc. The plurality of algorithms is stored in memory modules in the microprocessor control system (MCS) 30 and the MCS executes computer code, that is, executable code, which defines the plurality of algorithms and methods. The plurality of algorithms and methods utilize the control signals provided by at least one of the lower anchor sensors 28, the upper anchor sensor 29, the seatbelt buckle sensor 54, the occupancy sensors 52, 53, and the seatbelt payout sensor 56 to determine the presence of a child safety system 10 in a passenger seat 12 and determine if a message should be issued to the vehicle occupant, a ride action should be taken, or both a message should be issued to the vehicle occupant and a ride action should be taken, such as turning on or off selected airbag(s) 90 associated with the passenger seat 12 in an impact or preventing a ride from occurring. The plurality of algorithms and methods are described herein below.

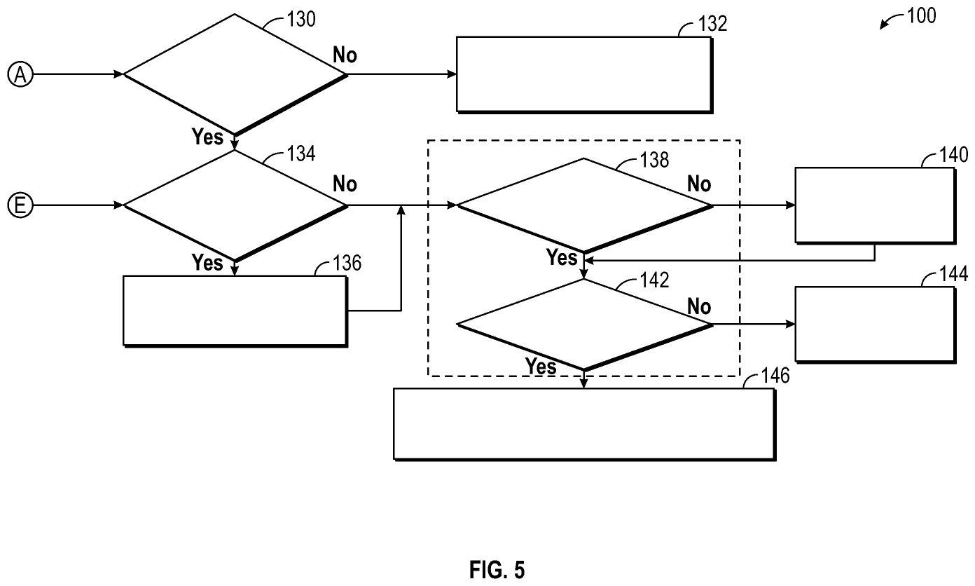

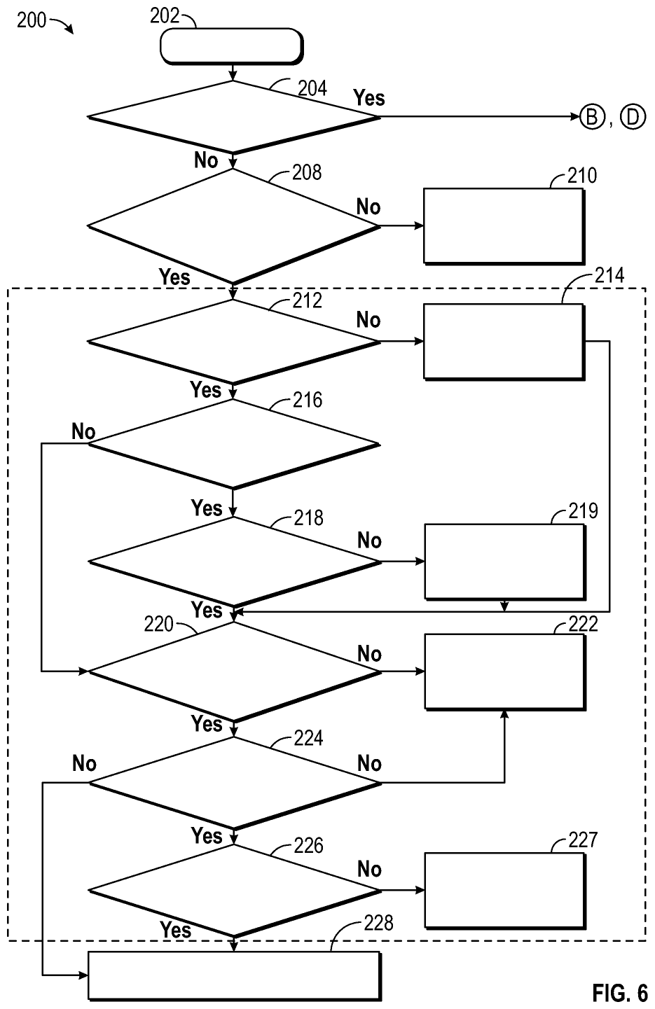

Referring now to FIG. 4, a flowchart illustrating a method 100 for detecting the presence of a child safety system 10 in a passenger seat 12 is illustrated. It should therefore be appreciated that the method 100 may be run for each passenger seat 12 including a LATCH system 11 or in which a child safety system 10 may be buckled into. The method begins at block 102, which occurs when, for example, the vehicle is started, a change in the occupant is detected by the occupancy sensors 52, 53, when a door is opened or shut, when the latch plate 48 is buckled into the buckle 50, or when the seatbelt 42 payout changes as detected by seatbelt payout sensor 56. At block 104 a determination is made as to whether the seatbelt 42 is buckled. This determination is made based on the signal sent by the seatbelt buckle sensor 54. In situations where it is determined that the seatbelt 42 has been buckled, the method follows line A to block 130 in FIG. 5.

If, at block 104, it is determined that the seatbelt 42 is not buckled, a determination of whether a child safety system 10 is present or absent in the passenger seat 12 is provisionally made at block 108. That is, a determination is made as to whether a child safety system 10, or something like a child safety system 10, or another object is present in the passenger seat 12. In aspects, this determination is made based on signals received from one or more of the following: occupancy sensor 52, occupancy sensor 53, payout length from seatbelt payout sensor 56 and combinations thereof, which indicate that an occupant or an object is present in the passenger seat 12. If a child safety system 10 is not determined to provisionally be present in the passenger seat 12, at block 110 several actions can be taken including looking for something else in the seat, issuing a message, or taking a ride action. For example at block 110, a determination of whether at least one of nothing, an object (different size classifications may be made), or an occupant (different size and posture classifications may be made) is present in the passenger seat 12 can be made based on signals from occupancy sensor 52 or occupancy sensor 53. If an occupant is deemed to be present, a determination of whether there has been a change in the seatbelt payout is made based on signals received from the seatbelt payout sensor 56, or a remote sensor like a camera such as could be the technology used for occupancy sensor 52. In further aspects, a message is issued to the occupant, a ride action is taken, or both a message is issued to the occupant and a ride action is taken. The message may include, for example, that an unrestrained object or person is in the passenger seat 12, and the ride action may include for example, not allowing a ride to proceed or ending a ride in a safe location until the object has been removed or the person properly restrained. Additional messages and ride actions are discussed further herein.

If a child safety system 10 is provisionally determined to be present at block 108, at block 112 a determination is made as to the presence or absence of a tether 26 connected to an upper anchor 18 and making a determination whether the tether 26 is connected to the upper anchor 18 based on signals received from the upper anchor sensor 29. If the tether 26 is not connected to the upper anchor 18, in aspects, at block 114 a message is issued to the occupant, a ride action is taken, or both a message is issued to the occupant and a ride action is taken. An example message includes, for example, at least one of a visual indication that the tether 26 is not connected to the upper anchor 18 and a dinging sound, recorded verbal message or other audible noise is made. An example of a ride action includes, for example, not allowing a ride to proceed or ending a ride in a safe location until either the tether 26 has been connected to the upper anchor 18 or the occupant has acknowledged and dismissed the error. Alternatively, no message and no ride action could be taken at block 114, as not all child safety systems 10 have a tether 26.

Regardless of whether the tether 26 is connected to the upper anchor 18, the process continues at block 116 and a determination from the output of lower anchor sensors 28 is then made as to the presence or absence of straps 20 connected to lower anchors 16 and determining whether straps 20 are attached to the lower anchors 16 based on signals received from the lower anchor sensors 28. If, at block 116 a determination is made that the straps 20 are not attached to the lower anchors 16 or only one lower anchor 16 associated with a passenger seat 12, at block 118 a message is issued to the occupant, a ride action is taken or both a message is issued to the occupant and a ride action is taken. For example, if there are no attachments to the lower anchors 16, a message may include an indication that the straps 20 are not connected to the lower anchors 16 and a ride action may include not allowing a ride to proceed or ending a ride in a safe location until the straps 20 have both been connected to the lower anchors 16, the seatbelt 42 has been buckled around the child safety system 10, or when allowable, the occupant has acknowledged the straps 20 are not connected to the lower anchors 16 and has dismissed the error. Further, in optional aspects, at block 118 a message is issued to the occupant, a ride action is taken, or both a message is issued to the occupant and a ride action is taken if it is determined that a strap 20 is connected to only one lower anchor 16 associated with a given passenger seat 12 and also if a strap is attached to a lower anchor 16 associated with another passenger seat 12. The message may include at least one of indicating to the occupant that the strap(s) 20 are not connected to both designated anchors 16 for the seating position and a dinging sound (or other audible noise/recorded verbal message) and the ride action may include not starting a ride or ending a current ride in a safe place until the strap 20 is connected to the correct lower anchors 16, or when allowable, the occupant has acknowledged a strap 20 are not connected to a lower anchor 16 and has dismissed the error.

If a determination is made at block 116 that the straps 20 are attached to both of the lower anchors 16, then at block 120 it is determined that a child safety system 10 is secured to the passenger seat 12, the system output and settings are saved in the in the microprocessor control system 30, and selected airbag(s) 90 associated with the passenger seat 12 that could be injurious to a child in a child safety system 10 are disabled.

It is to be appreciated that in alternative aspects, the operations in blocks 112 and 116 may be reversed, where first a determination is made as to whether a straps 20 are connected to the lower anchors 16 before a determination is made as to whether a tether 26 is connected to the upper anchor 18. It should also be appreciated that in some cases that the lower anchors associated with a certain passenger seat 12 may include at least one anchor from an adjacent seating position, such as possibly for a middle seating position where the inboard anchor from the adjacent outboard seating positions are used for this center seating position.

Referring again to block 104, if a determination is made that the seatbelt 42 associated with a passenger seat 12 is buckled then the process follows line A to FIG. 5 and a determination is provisionally made at block 130 as to whether a child safety system 10, or something like a child safety system 10, is present in the passenger seat 12. Again, this determination may be made based on, e.g., one or more of the following: signals received from the seatbelt payout sensor 56, signals received from the occupancy sensor 52, signals received from the occupancy sensor 53, and combinations thereof, which indicate that a passenger or an object, such as a child safety system 10, is present in the passenger seat 12. If a child safety system 10 is not determined to provisionally be present, then at block 132 several actions can be taken including looking for something else in the seat, issuing a message, or taking a ride action. For example, at block 132, a determination of whether at least one of nothing, an object (different size classifications may be made), or an occupant (different size and posture classifications may be made) is present in the passenger seat 12 can be made based on signals from occupancy sensor 52 or occupancy sensor 53. If an occupant is deemed to be present, a determination of whether the seatbelt 42 is properly routed is made based on signals received from the seatbelt payout sensor 56, the occupancy sensor 52, the occupancy sensor 53 or some combination of these sensors. In aspects, a message is issued to the occupant, a ride action is taken, or both a message is issued to the occupant and a ride action is taken. The message may include at least one of a visual indication that a person with a misrouted seatbelt 42 is present in the passenger seat 12 and an audible sound (such as a dinging sound or recorded verbal message). A ride action may include for example, not allowing a ride to proceed or ending a ride in a safe location until the person is properly restrained.

If at block 130 a provisional determination is made that a child safety system 10, or something like a child safety system 10, is present, optionally, a determination is made at block 134 as to whether a child safety system 10 was previously present in the passenger seat 12. This determination is made relative to the last time the algorithm and method 100 were run. If it is determined that there is a change in whether a child safety system 10 was present in the passenger seat 12, then the microprocessor control system 30 optionally issues a message to the occupant, takes a ride action, or both issues a message and takes a ride action at block 136. The method then proceeds from block 136 to block 138. Likewise, if it is determined that the presence of a child safety system 10 in the passenger seat 12 has not changed at block 134, then the method also proceeds to block 138 where a determination by the output of upper anchor sensor 29 is made as to the presence or absence of a tether 26 connected to the upper anchor 18 and making a determination if the tether 26 is connected to the upper anchor 18 at block 138. If the tether 26 is not connected to the upper anchor 18 then at block 140 the microprocessor control system 30 issues a message to the occupant, takes a ride action until the upper anchor 18 is attached, or both issues a message to the occupant and takes a ride action. The message includes at least one of indicating to the vehicle occupant(s) that the tether 26 is not connected to the upper anchor 18 even though something like a child safety system 10 is present in the passenger seat 12 and an audible sound (such as a dinging sound or verbal message). An example of ride action includes not starting a ride or ending a ride in a safe location until the occupant connects the tether 26 to the upper anchor 18 or until the occupant acknowledges that the tether 26 is not connected to the upper anchor 18 and dismisses the error. Alternatively, no message and no ride action could be taken at block 140, as not all child safety systems 10 have a tether 26.

Regardless of whether a tether 26 is attached to an upper anchor 18, the method 100 then proceeds to block 142 where a determination is made by the output of lower anchor sensors 28 as to the presence or absence of straps 20 connected to lower anchors 16 and making a determination if the if the straps 20 are attached to both of the lower anchors 16 associated with a given passenger seat 12. If the straps 20 are not attached to both of the lower anchors 16 then at block 144 the microprocessor control system 30, does nothing, issues a message to the occupant, takes a ride action until the lower anchors 16 are attached, or both issues a message to the occupant and takes a ride action. The message includes at least one of indicating to the vehicle occupant(s) that both of the lower straps 20 are not connected to the lower anchors 16 even though something like a child safety system 10 is present in the passenger seat 12 and an audible noise (such as a dinging sound or verbal message). An example of ride action includes not starting a ride or ending a ride in a safe location until the occupant connects the lower straps 20 to the both lower anchors 16 or until the occupant acknowledges that the straps 20 are not connected to the lower anchors 16 and dismisses the error.

If the country in which the vehicle is being used or the child safety system 10 doesn't require that lower straps 20 be attached to lower anchors 16 since the seatbelt 42 is being used to restrain the child safety system, no message could be given and the ride could be enabled in block 144.

If it is determined that the straps 20 are attached to both of the lower anchors 16, then at block 146 at least one of: a ride is prohibited due to redundant use of the seatbelt 42 and lower anchor, a message is issued to the occupant that redundant use of belt and lower anchors is in use, and for countries or child safety system 10 designs that do not allow simultaneous attachment of a child safety system 10 to lower anchors 16 and to a seatbelt 42 a ride action is taken until the attachment of the strap(s) 20 is addressed, acknowledged or dismissed. For countries or child safety system 10 designs where simultaneous attachment is allowed, no message could be provided at block 146.

At block 146, the system output and settings are also saved in the in the microprocessor control system 30. At block 146 selected airbags 90 associated with the passenger seat 12 are disabled.

Optionally, if a determination is made at block 142 that the straps 20 is connected only to one of the lower anchors 16 associated with a given passenger seat 12, the method continues to block 144 and at least one of a message and a ride action is taken. An example of a message may include at least one of: an indication to the occupant that the strap 20 is connected to less than the two designated anchors for the seating position and a dinging sound (or other audible noise) and the ride action may include not starting the ride or ending the current ride in a safe place until the strap(s) 20 is connected to the correct lower anchors 16 or the attached strap is disconnected for child safety system 10 or countries where simultaneous lower anchor 16 attachment and seat belt 42 attachment are not allowed.

It is to be appreciated that in alternative aspects, the operations in blocks 138 and 142 may be reversed, where first a determination is made as to whether straps 20 are connected to the lower anchors before a determination is made as to whether a tether 26 is connected to the upper anchor 18.

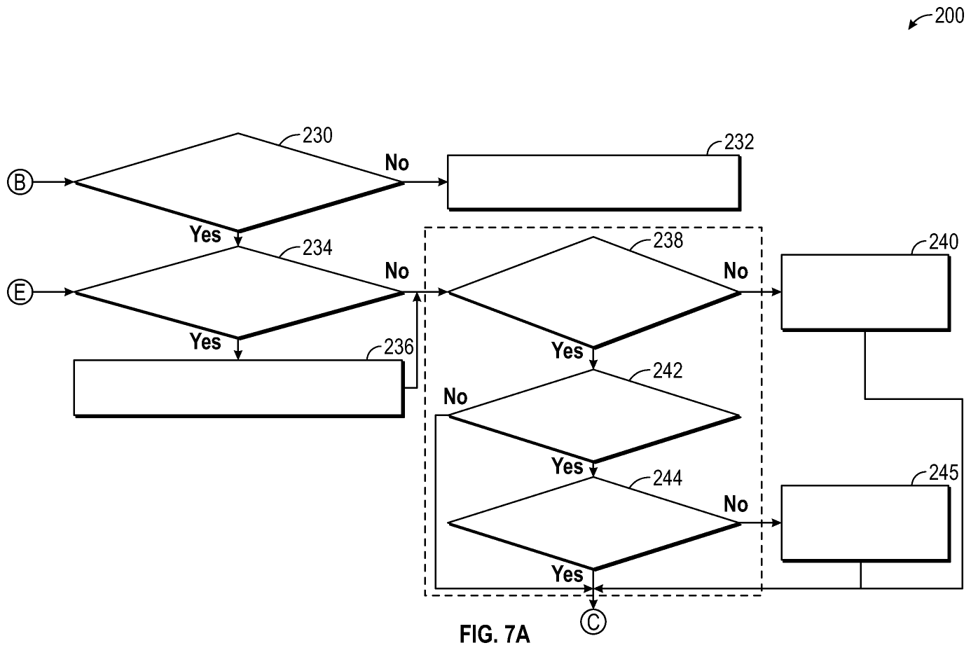

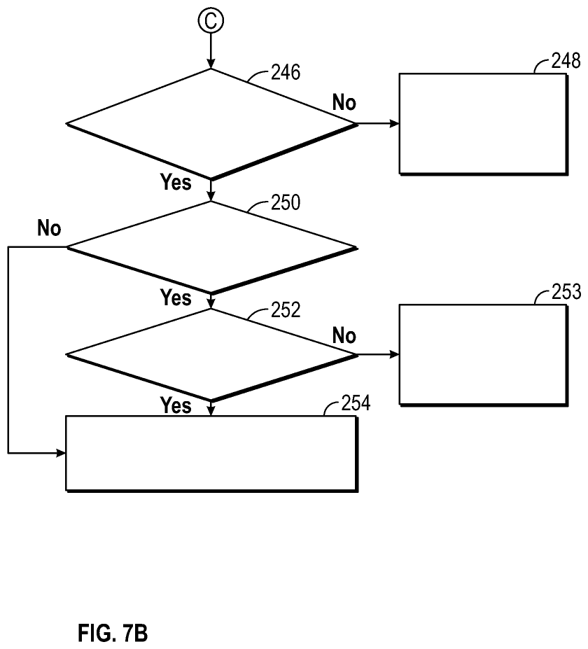

In aspects, where the anchor sensors 28, 29 detect tension, the method 200 described in FIGS. 4 and 5 may be altered to account for tension. For example, with reference to FIGS. 6 and 7, a method 200 is described that takes into account the flexibility of the lower anchors 16 and upper anchor 18 when verifying the presence of the child safety system 10 in a passenger seat 12. The method begins at block 202, which occurs when, for example, the vehicle is started, a change in the occupant is detected by the occupancy sensors 53, 52, when a door is opened, or when a seatbelt payout change is detected by seatbelt payout sensor 56. At block 204 a determination is made as to whether the seatbelt 42 is buckled. This determination is made based on the signal sent by the seatbelt buckle sensor 54. In situations where it is determined that the seatbelt 42 has been buckled, the method continues along line B to FIG. 7, beginning at block 230.

If, at block 204, it is determined that the seatbelt 42 is not buckled, a provisional determination of whether a child safety system 10 is present in the passenger seat 12 is made at block 208. In aspects, this determination is made based on signals received from one or more of the following: occupancy sensor 52, occupancy sensor 53, and combinations thereof, which indicate that an occupant, child safety system 10 or an object is present in the passenger seat 12. If a child safety system 10 is not provisionally determined to be present in the passenger seat 12, at block 210, several actions can be taken including looking for something else in the passenger seat 12, issuing a message, or taking a ride action. For example, at block 210, a determination of whether at least one of nothing, an object (different size classifications may be made), or an occupant (different size and posture classifications may be made) is present in the passenger seat 12 can be made based on signals from occupancy sensor 52 or occupancy sensor 53. If an occupant is deemed to be present, a determination of whether there has been a change in the seatbelt payout is made based on signals received from the seatbelt payout sensor 56 or a remote sensor like a camera such as could be the technology used for occupancy sensor 52. In further aspects, a message is issued to the occupant, a ride action is taken, or both a message is issued to the occupant and a ride action is taken. The message may include, for example, that an unrestrained object or person is in the passenger seat 12, and the ride action may include for example, not allowing a ride to proceed or ending a ride in a safe location until the object has been removed or the person properly restrained. Additional messages and ride actions are discussed further herein.

If a child safety system 10 is provisionally determined to be present at block 208, at block 212 a determination is made whether a tether 26 is connected to the upper anchor 18 based on signals received from the upper anchor sensor 29. If the tether 26 is not connected to the upper anchor 18, in aspects, at block 214 a message is issued to the occupant, a ride action is taken, or both a message is issued to the occupant and a ride action is taken. An example message includes, at least one of: an indication that the tether 26 is not connected to the upper anchor 18 and a dinging sound or other audible noise such as a verbal message. An example of a ride action includes, for example, not allowing a ride to proceed or ending a ride in a safe location until either the tether 26 has been connected to the upper anchor 18 or the occupant has acknowledged and dismissed the error. Alternatively, no message and no ride action could be taken at block 214, as not all child safety systems 10 have a tether 26.

If the tether 26 is connected to the upper anchor 18, at block 216 a determination is made as to whether the upper anchor 18 can be tensioned. This determination can be accomplished by recognizing the type of child safety system 10 present from an internal sensor such as occupancy sensors 52, 53, a LATCH attachment characteristic signal pattern from upper anchor sensor 29 of a tether 26 attached to an anchor 18, or an input from a ride reservation application, or other input from the vehicle user that is stored in the microprocessor control system 30. Note that a rigid tether 26 that cannot be tensioned significantly exerts a different force or loading characteristic on the upper anchor 18 than a flexible tether 26 that can be tensioned. For example, small motions on a child safety system 10 with a rigid tether exert a different load pattern on the anchor 16 than a flexible tether. The load pattern can be monitored by the upper anchor sensor 29. If a determination is made that the tether 26 can be tensioned, then the tension applied to the upper anchor 18 is checked at block 218 and compared to a predefined tension threshold or a predetermined tension threshold range to determine if the tension is correct. The tension threshold or tension threshold range could be a force level that is hard coded into an algorithm or is a calibratable magnitude which is compared to the measured tension determined from upper anchor sensor 29. In aspects, the determination if the tension is correct at block 218 is made at the same time the determination is made that the tether 26 is connected to the upper anchor 18. That is, the signal received from the upper anchor sensor 29 indicates, not only that the tether 26 is connected to the anchor 18, but also the amount tension on the anchor 18 applied by the tether 26. Alternatively, the determination of whether the tension may be made after a determination is made that the tether 26 is connected to the upper anchor 18. If the tension is incorrect (below a predetermined threshold or outside a predetermined tension threshold range) at block 218, at block 219 a message is issued to the occupant, a ride action is taken or both a message is issued and a ride action is taken until the tension is corrected or the warning is dismissed by the riders. The message may include at least one or more of: indicating to the occupant that the tension on the upper anchor 18 needs to be adjusted and a dinging sound or other audible noise such as a verbal message and a ride action may include not beginning a ride or ending an in progress ride until the tension applied to the upper anchor 18 by the tether 26 is properly adjusted.

Regardless of whether the tether 26 is connected to the upper anchor 18, at block 212, whether the upper anchor 18 is determined to be of a configuration that can be tensioned at block 218, or whether the tension on the upper anchor 18 is correct (above a predetermined threshold or within a predetermined tension threshold range) at block 218, a determination is then made at block 220 as to whether straps 20 are attached to the lower anchors 16 based on signals received from the lower anchor sensors 28. If, at block 220 a determination is made that the straps 20 are not attached to both of the lower anchors 16, at block 222 a message is issued to the occupant, a ride action is taken or both a message is issued to the occupant and a ride action is taken. The message may include at least one of the following: indicating to the occupant that the straps 20 are not attached to at least one of the lower anchors 16, the seatbelt 42 has not been used to restraint the child safety system 10 and or a dinging sound or other audible noise such as verbal message and the ride action may include not beginning a ride or ending a current ride until the straps 20 are connected to the lower anchors 16, the CRS is restrained by a seatbelt 42 or possibly if allowed the occupant acknowledges the warning and dismisses it.

If a determination is made at block 220 that the straps 20 are attached to at least one of the lower anchors 16, then at block 224 a determination is made if the straps 20 can be tensioned. This determination can be accomplished by recognizing the type of child safety system 10 present from an internal sensor such as occupancy sensors 52, 53, a LATCH attachment characteristic signal pattern from straps 20 attached to lower anchors 16, or an input from a ride reservation application, or other input from the vehicle user that is stored in the microprocessor control system 30. Note that rigid straps 20 that cannot be significantly tensioned would have different force and loading characteristics on the lower anchors 16 than flexible webbing straps 20 that can be tensioned, as small motions on a child safety system 10 with rigid straps would produce a different load pattern on the lower anchors 16 than flexible straps that can be tensioned. In addition, both lower straps 20 on a child safety system 10 would be attached nearly simultaneously with rigid straps 20 and have a similar load pattern timewise on both lower anchors 16. The load patterns can be monitored by the lower anchor sensors 28. If it is determined at block 224 that the lower straps 20 can be tensioned, then at block 226 a determination is made as to whether the tension on the lower anchors 16 is correct, such as having a measured tension above a predetermined tension threshold , within a predetermined tension range or that the measured tension for both lower anchor sensors 28 is applied within a predetermined short duration time window if loading characteristics on the lower anchor sensors 28 indicate that rigid straps are present. The predetermined tension threshold or range could be a force level (or levels), force range (or ranges) that is hard coded into an algorithm or is a calibratable magnitude which is compared to the measured tension determined from lower anchor sensors 28. Likewise, the acceptable time window could be hard coded into an algorithm or be a calibratable magnitude. Again, information regarding the measured tension may be transmitted by the lower anchor sensors 28 at the same time a determination is made as to whether the straps 20 are attached the lower anchors 16. Alternatively, the determination of whether the tension is correct (above a predetermined tension threshold or within a range and/or applied to both lower anchors 16 within a short duration time window if loading characteristics on the lower anchor sensors 28 indicate that rigid straps are present) may be made after the determination is made of whether the straps 20 are connected to the lower anchors 16. If it is determined that the tension is not correct (below a predetermined threshold or outside a predetermined threshold range and/or not applied to both lower anchors 16 within a short duration time window if loading characteristics on the lower anchor sensors 28 indicate that rigid straps are present) at block 226 then at block 227 a message is issued to the occupant, a ride action is taken until the tension is addressed, or both a message is issued and a ride action is taken. Such a message may include indicating to the occupant at least one of: the tension is incorrect and a dinging sound or other audible noise such as a verbal message and a ride action may include not beginning a ride or ending an in-process ride until the tension on the lower anchors 16 are adjusted or until the occupant acknowledges and dismisses the warning.

If it is determined that the lower straps 20 cannot be tensioned at block 224 or that the tension on lower anchors 16 is correct (above a predetermined tension threshold or within a range and/or applied to both lower anchors 16 within a short duration time window if loading characteristics on the lower anchor sensors 28 indicate that rigid straps are present)) at block 226, then the system output and settings are saved in the microprocessor control system at block 228 and some of the airbag(s) 90 associated with the passenger seat 12 may be disabled. It is to be appreciated that in alternative aspects, the operations in blocks 212 and 220 may be reversed, where first a determination is made as to whether a strap(s) 20 are connected to the lower anchors 16 before a determination is made as to whether a tether 26 is connected to the upper anchor 18.

Turning now to FIG. 7A, if a determination is made that the seatbelt 42 associated with a passenger seat 12 is buckled at block 204 in FIG. 6, following line B, a determination is provisionally made at block 230 as to whether a child safety system 10, or something like a child safety system 10, is present in the passenger seat 12. Again, this determination may be made based on, for example, one or more of the following: signals received from the seatbelt payout sensor 56, signals received from the occupancy sensor 52, signals received from the occupancy sensor 53, and combinations thereof, which indicate that a passenger or an object, such as a child safety system 10, is present in the passenger seat 12. If a child safety system 10, or something like a child safety system, is not determined to be present at block 230, then at block 232 several actions can be taken including looking for something else in the seat, issuing a message, or taking a ride action. For example, at block 232, a determination of whether at least one of nothing, an object (different size classifications may be made), or an occupant (different size and posture classifications may be made) is present in the passenger seat 12 can be made based on signals from occupancy sensor 52 or occupancy sensor 53. If an occupant is deemed to be present, a determination of whether the seatbelt 42 is properly routed is made based on signals received from the seatbelt payout sensor 56, the occupancy sensor 52, the occupancy sensor 53 or some combination of these sensors. In aspects, a message is issued to the occupant, a ride action is taken, or both a message is issued to the occupant and a ride action is taken. The message may include at least one of an indication that a person with a misrouted seatbelt 42 is present in the passenger seat 12 and a dinging sound or other audible noise such as a verbal message, and the ride action may include, for example, not allowing a ride to proceed or ending a ride in a safe location until the person is properly restrained. Additional messages and ride actions are discussed further herein.

If, in FIG. 7A at block 230, a provisional determination is made that a child safety system 10, or something like a child safety system 10, is present, optionally a determination is made at block 234 as to whether a child safety system 10 was previously present in the passenger seat 12. This determination is made relative to the last time that the algorithm is run. If it is determined at block 234 that there is a change in the status of the child safety system 10 being present in the passenger seat 12 at block 234, then the microprocessor control system 30 optionally issues a message to the occupant, takes a ride action, or both issues a message and takes a ride action at block 236. The method then proceeds from block 236 to block 238. Likewise, if it is determined that the status of the child safety system 10 being present in the passenger seat 12 has not changed at block 234, then the method also proceeds to block 238 where a determination is made as to whether a tether 26 is connected to the upper anchor 18 at block 238. If the tether 26 is not connected to the upper anchor 18 then at block 240 the microprocessor control system 30 issues a message to the occupant, takes a ride action until the upper anchor 18 is attached, or both issues a message to the occupant and takes a ride action. Similar to the above, the message may include at least one of the following: indicating to the vehicle occupant that the tether 26 is not connected to the upper anchor 18 and a dinging sound or other audible noise such as a verbal message, and the ride action may include not beginning a ride or ending a ride in progress until the tether 26 is connected or until the occupant acknowledges and dismisses the warning that the tether 26 is not connected to the upper anchor 18. If the child safety system 10 doesn't require that tether 26 be attached to upper anchor 18 since the seatbelt 42 is being used to restrain the child safety system, no message could be given and the ride could be enabled in block 240. Alternatively, no message and no ride action could be taken at block 240, as not all child safety systems 10 have a tether 26.

If it is determined that the tether 26 is connected to the upper anchor 18 at block 238, then a determination is made as to whether the tether 26 can be tensioned at block 242. In aspects, this determination is made by recognizing the type of child safety system 10 present from an internal sensor such as occupancy sensors 52, 53, a LATCH attachment characteristic signal pattern from a tether 26 attached to an anchor 18, an input from a ride reservation application, or other input from the vehicle user that is stored in the microprocessor control system 30. Note that a rigid tether 26 that cannot be significantly tensioned would have a different force, loading characteristic, on the upper anchor 18 than a flexible tether 26 that can be tensioned. For example, small motions on a child safety system 10 with a rigid tether exert a different load pattern on the anchor 16 than a flexible tether. The load pattern can be monitored by the upper anchor sensor 29. If it is determined that the tether 26 can be tensioned at block 242, then a determination is made as to whether the tension on the upper anchor 18 is correct (above a predetermined tension threshold or within a predetermined tension threshold range) at block 244. The tension threshold or tension threshold range could be a force level or range that is hard coded into an algorithm or is a calibratable magnitude which is compared to the measured tension determined from upper anchor sensor 29. If at block 244 it is determined that the tension on the upper anchor 18 is not correct (below a predetermined tension threshold or outside a predetermined tension threshold range) then a message is issued to the occupant, a ride action is taken until the tension is address, or a message is issued and a ride action is taken until the tension is addressed at block 244. The message may include indicating to the occupant that the tension on the upper anchor 18 needs to be adjusted or an audible sound is made such as a dinging sound, verbal message or other sound and the ride action may include not beginning a ride or ending a ride in progress until the occupant acknowledges and dismisses a warning that the tension on the upper anchor 18 needs to be adjusted.

If it is determined at block 244 that the tension on the upper anchor 18 is correct or if it is determined at block 242 that the upper anchor 18 cannot be tensioned, then the logic proceeds from block 244 and path “C” in FIG. 7A to path “C” in FIG. 7B and to block 246 where a determination is made as to whether the strap(s) 20 are attached to one or both of the lower anchors 16. If the straps 20 are not attached to both of the lower anchors 16 then at block 248 the microprocessor control system 30 concludes that the child safety system 10 is attached to the vehicle by the seatbelt 42. The microprocessor control system 30 optionally checks at least one of the following: the seatbelt payout, the guide loop position and the passenger seat position and referencing signals from the seatbelt payout sensor 56, the guide loop position sensor 47, and the passenger seat sensor 82, which determines the location of the passenger seat relative to a given point in the vehicle, such as the B-pillar 60 or a cross member 36. Selected airbags may also be suppressed, a message may optionally be provided, and the ride will be allowed to progress.

Optionally, a determination is made at block 246 whether the straps 20 are connected only to one of the lower anchors 16 associated with a given passenger seat 12, at block 248, a message is issued to the occupant, an additional ride action is taken, or both a message is issued to the occupant and an additional ride action is taken. An example of a message may include at least one of an indication to the occupant that the strap 20 is connected to less than the two designated anchors for the seating position and an audible sound such as a dinging sound, verbal message, or other sound is made and the ride action may include not starting the ride or ending the current ride in a safe place until the straps 20 are connected to the correct lower anchors 16. If the country in which the vehicle is being used or the child safety system 10 doesn't require that lower straps 20 be attached to lower anchors 16 since the seatbelt 42 is being used to restrain the child safety system, no message could be given and the ride could be enabled in block 248.

If it is determined at block 246 that the straps 20 is attached to at least one of the lower anchors 16, then at block 250 a determination is made as to whether the lower straps 20 can be tensioned. This determination can be accomplished by recognizing the type of child safety system 10 present from an internal sensor such as occupancy sensors 52, 53, a LATCH attachment characteristic signal pattern from a strap 20 attached to a lower anchor 16, or an input from a ride reservation application, or other input from the vehicle user that is stored in the microprocessor control system 30. Note that rigid straps 20 that cannot be tensioned in a manner similar to flexible straps 20 and exert different force and loading characteristics on lower anchors 16 than straps 20 that can be tensioned. In addition, both lower tethers on a child safety system 10 would be attached nearly simultaneously with rigid straps 20 and have a similar load pattern timewise on both lower anchors 16. The load patterns can be monitored by the lower anchor sensors 28. If it is determined that the lower straps 20 can be tensioned at block 250, then at block 252 a determination is made as to whether there is correct tension (above a predetermined tension threshold, within a given a predetermined threshold range and/or that the measured tension for both lower anchor sensors 28 is applied within a predetermined short duration time window if loading characteristics on the lower anchor sensors 28 indicate that rigid straps are present) applied to the lower anchors 16. The predetermined tension threshold (or threshold range) could be a force level (or levels) or force range (or ranges) that is hard coded into an algorithm or is a calibratable magnitude which is compared to the measured tension determined from lower anchor sensors 28. Likewise, the acceptable time window could be hard coded into an algorithm or be a calibratable magnitude. If the incorrect tension (below a predetermined tension threshold or outside of a predetermined tension threshold range and/or not applied to both lower anchors 16 within a short duration time window if loading characteristics on the lower anchor sensors 28 indicate that rigid straps are present) is being applied to the lower anchors 16, then at block 253 a message is issued to the occupant, and a ride action is taken, or both a message is issued to the occupant and a ride action is taken until the tension of the straps 20 applied to the lower anchors 16 is addressed. If it is determined that the lower anchors 16 cannot be tensioned at block 246 or that the appropriate tension (above a predetermined tension threshold or within a range and/or applied to both lower anchors 16 within a short duration time window if loading characteristics on the lower anchor sensors 28 indicate that rigid straps are present) is applied to the lower anchors 16 at block 252 then the method proceeds to block 254.

At block 254 at least one of a ride is allowed to progress, message is issued to the occupant and for countries or child safety system 10 designs that do not allow simultaneous attachment of a child safety system 10 to lower anchors 16 and to a seatbelt 42, a ride action is taken until the attachment of the straps 20 is addressed, acknowledged or dismissed. Selected airbags 90 associated with the passenger seat 12 are disabled at block 254. The system output and settings are also saved in the in the microprocessor control system 30.

It is to be appreciated that in alternative aspects, the operations in blocks 238 and 246 may be reversed, where first a determination is made as to whether straps 20 are connected to the lower anchors before a determination is made as to whether a tether 26 is connected to the upper anchor 18.

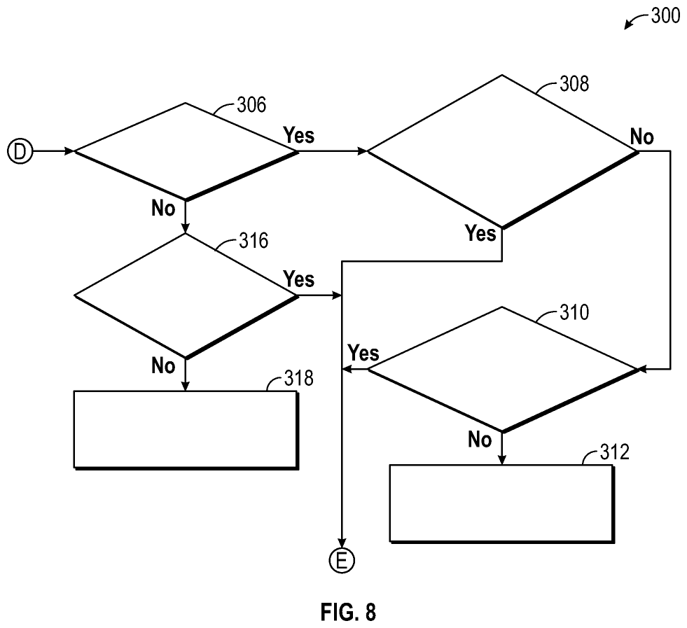

In yet a further aspect, illustrated in FIG. 8, the method 300 includes the step of determining whether something is present in the vehicle seat at the time a seatbelt 42 is buckled, such as illustrated in FIG. 5 or 7. After a determination is made at block 104 in FIG. 4 or at block 204 in FIG. 6, that the seatbelt 42 is buckled, then following line D, a first determination is made as to whether something is present at the time of buckling at block 306 in FIG. 8. If it is determined that something was present in the passenger seat 12 at the time of buckling at block 306, then a second determination may be made at block 308 if something was not present for more than a set time period (a calibratable input or hard programmed amount of time) after buckling. This is to detect if someone is leaning on a child safety system 10 at the time of buckling as they would off load it after buckling prior to the child getting into the child safety system 10. Thus, a pressure based or mass-based occupancy sensor 53 in the passenger seat 12 would have an intermittent signal. If a large occupant was sitting in the seat at the time of buckling, they would not unload the occupancy sensor and there would not be an intermittent pattern to the pressure based or mass based occupancy sensor 53 in the passenger seat 12.

If something was not continually present in the seat for more than a set time period at block 308, then a provisional determination is optionally made at block 310 with occupancy sensors 52, 53 as to whether a child safety system 10 or something like a child safety system 10 is present in the passenger seat 12. For a pressure based or mass based system, the determination in block 310 may be the same logic as in block 308 where a child safety system 10 or something like a child safety system 10 is deemed to be present if something was not detected as present for more than a set time period (a calibratable input or hard programmed amount of time) such as for example, something not present for 10 seconds in a 60 second window after buckling. If a remote sensor, such as occupancy sensor 52 is used, an image from that sensor could be used to make the determination in block 310.

If it is determined that a child safety system 10, or something like a child safety system 10, is not present at block 310, then at block 312 several actions can be taken including looking for something else in the seat, issuing a message, taking a ride action or doing nothing. For example, at block 312, a determination of whether at least one of nothing, an object (different size classifications may be made), or an occupant (different size and posture classifications may be made) is present in the passenger seat 12 can be made based on signals from occupancy sensor 52 or occupancy sensor 53. If an occupant is deemed to be present, a determination of whether the seatbelt 42 is properly routed is made based on signals received from the seatbelt payout sensor 56, the occupancy sensor 52, the occupancy sensor 53 or some combination of these sensors. In aspects, a message is issued to the occupant, a ride action is taken, or both a message is issued to the occupant and a ride action is taken. The message may include at least one of an indication that a person with a misrouted seatbelt 42 is present in the passenger seat 12 and a dinging sound or other audible noise such as a verbal message is issued, and the ride action may include for example, not allowing a ride to proceed or ending a ride in a safe location until the person is properly restrained. Additional messages and ride actions are discussed further herein. If it is provisionally determined that a child safety system 10 is present at block 310, then the method continues and the method picks up at either block 134 of FIG. 5 or block 234 of FIG. 7A following line E.

If at block 306, it is determined that something is not present, then the method continues to block 316 where a provisional determination is optionally made with occupancy sensors 52, 53 as to whether a child safety system 10 or something like a child safety system 10 is present in the passenger seat 12. For a pressure based or mass based system, the determination in block 316 may be the same logic as in block 306 where a child safety system 10 or something like a child safety system 10 is deemed to not be present if something was not detected as present. If a remote sensor, such as occupancy sensor 52 is used, an image from that sensor could be used to make the determination in block 316.

If it is determined that a child safety system 10, or something like a child safety system 10, is not present at block 316, then at block 318 several actions can be taken including issuing a message, taking a ride action or doing nothing. For example, at block 318, a message could be given that there is a buckled seatbelt with nothing detected in the seating position.

If it is provisionally determined that a child safety system 10 is present at block 316, then the method continues and the method picks up at either block 134 of FIG. 5 or block 234 of FIG. 7A following line E.

Messages issued to the occupant in the methods above include, for example, a warning, which may be a visual warning such as one displayed on a display screen or dashboard 92 or an auditory warning, such as one verbally describing a condition or a dinging sound. Additional examples of messages include visual and audible messages: a) instructing the occupant to buckle the child safety system 10 in the passenger seat 12, b) instructing the occupant to buckle an object into the passenger seat 12, c) instructing the occupant to adjust the strap or tether connections by attaching them or reattaching them in another location, d) instructing the occupant to apply tension to a strap 20 or tether 26, e) instructing the occupant to place an object in another location, such as in a storage compartment and f) advising the occupant an airbag has been disabled, f) instructing that an improperly secured person or object is present in a passenger seat 12. Ride actions include a) disabling of selected airbags, b) preventing a ride from starting until an issue is addressed, and c) slowing a ride down or routing it to a safe place to stop until an issue is addressed, such as the relocation of a strap(s) 20 connected to the wrong lower anchor 16, the adjustment of the tension on a lower anchor 16 or upper anchor 18, etc. If an unresolvable conflict exists, an administrator, such as a ride assist provider, may be contacted to view and approve a condition to enable a ride.

In aspects, the methods 100, 200, 300, 400 illustrated in FIGS. 4 through 8 the process begins at block 102, block 202 either 1) after a given time interval, 2) continuously, 3) upon the vehicle starting, 4) a change is measured by the occupancy sensors 52, 53, or seatbelt payout sensor 56 or 5) the seatbelt 42 is buckled or unbuckled. Thus, it should be appreciated that the methods 100, 200 may repeat one or more times during a ride or during a given period of time where the vehicle is on. At the end of the logic flow, for each path of each method, the method can start at the beginning or pick up where a decision box has changed states. Within the methods discussed herein, it is possible to have a detection approach a) where only the upper anchor 18 usage and possibly tension is detected, b) where only the lower anchors 16 usage and possibly tension is detected, and c) where both the upper anchor 18 and the lower anchors 16 usage and possibly tension is detected.

A lower and upper anchor use detection sensing device of the present disclosure offers several advantages. These advantages include the disabling of selected airbags associated with a passenger seat 12 if a child safety system is verified as being present in the passenger seat 12. These advantages also include providing a message to an occupant or taking a ride action if there appear to be issues with the child safety system, such as either the tether 26 not being connected to the upper anchor 18 or the strap(s) 20 not being connected to the lower anchors 16.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A system for determining when a child safety system is present in a passenger seat in a vehicle, comprising:
at least one of: a) two lower anchors each including a lower anchor sensor for sensing a presence of a strap connected to each lower anchor, or b) an upper anchor including an upper anchor sensor for sensing a presence of a tether connected to the upper anchor;
an occupancy sensor for provisionally sensing a child safety system present in the passenger seat;
a seatbelt buckle sensor for sensing a presence of a latch plate in the seatbelt buckle, when the latch plate is connected to a seatbelt; and
a microprocessor control system in communication with at least one of the lower anchor sensors, the upper anchor sensor, the occupancy sensor, and the seatbelt buckle sensor, wherein the microprocessor control system includes executable code to:
provisionally determine whether the child safety system is detected in the passenger seat;
determine whether at least one of: a) the straps are connected to each lower anchor and b) the tether is connected to the upper anchor;
determine whether the seatbelt is buckled;
verify the presence of the child safety system in the passenger seat
identify an issue when the child safety system is provisionally detected in the passenger seat and the seatbelt is not buckled, the straps are not connected to each lower anchor, or the tether is not connected to the upper anchor; and
perform a ride action if the issue is identified, wherein the ride action consists of preventing a ride from starting until the issue is no longer identified or slowing the ride down and routing the ride to a safe place to stop until the issue is no longer identified.

2. The system of claim 1, wherein the microprocessor control system further includes executable code to determine if a correct tension is applied to at least one of: a) the lower anchors and b) the upper anchor.

3. The system of claim 1, further comprising a seatbelt payout sensor for sensing a seatbelt payout length in communication with the microprocessor control system, and wherein the microprocessor control system further includes executable code to: compare the seatbelt payout length to a first seatbelt payout length threshold.

4. The system of claim 1, wherein the microprocessor control system further comprises executable code to: issue a message when the seatbelt is not buckled, the child safety system is provisionally detected in the passenger seat, and the strap is not connected to at least one of the lower anchors.

5. The system of claim 1, wherein the microprocessor control system further comprises executable code to: issue a message when the seatbelt is not buckled, the child safety system is provisionally detected in the passenger seat, the tether is connected to the upper anchor, and the strap is not connected to at least one of the lower anchors.

6. The system of claim 1, wherein the microprocessor control system further comprises executable code to: issue a message when the seatbelt is not buckled, the child safety system is provisionally detected in the passenger seat, the straps are connected to the lower anchors and the tether is not connected to the upper anchor.

7. The system of claim 1, wherein the microprocessor control system further comprises executable code to: issue a message when the seatbelt is buckled, the child safety system is provisionally detected in the passenger seat, and the tether is not connected to the upper anchor.

8. The system of claim 1, wherein the microprocessor control system further comprises executable code to: issue at least one of a message and no action, when the seatbelt is buckled, the child safety system is provisionally detected in the passenger seat, the strap is connected to the lower anchors, and the tether is connected to the upper anchor.

9. The system of claim 1, wherein the microprocessor control system further comprises executable code to: determine whether to disable a restraint associated with the passenger seat, wherein the restraint comprises an airbag associated with the passenger seat and the microprocessor control system includes executable code to: disable deployment of at least one airbag when the child safety system is verified in the passenger seat.

10. A method for detecting when a child safety system is present in a passenger seat in a vehicle, comprising:
sensing at least one of: a) a presence or absence of a strap connected to at least one of two lower anchors associated with a passenger seat and b) a presence or absence of a tether connected to an upper anchor;
sensing a presence or absence of a latch plate in a seatbelt buckle, wherein the latch plate is connected to a seatbelt;
determining if the tether is a flexible tether or a rigid tether by comparing a load sensed from the tether to flexible tether load pattern and a rigid tether flexible load pattern;
determining at least one of a) whether the strap is connected or not connected to at least one of the two lower anchors and b) whether the tether is connected or not connected to the upper anchor;
provisionally sensing a presence or absence of a child safety system in the passenger seat;
provisionally determining whether the child safety system is present or absent from the passenger seat;
determining the child safety system is absent if the child safety system was present in the passenger seat for less than a set time period after the latch plate has been sensed in the seatbelt buckle;
identifying an issue when the child safety system is detected in the passenger seat and the latch plate is not buckled, the straps are not connected to each lower anchor, or the tether is not connected to the upper anchor; and
performing a ride action if the issue is identified, wherein the ride action consists of preventing a ride from starting until the issue is no longer identified or slowing the ride down and routing the ride to a safe place to stop until the issue is no longer identified.

11. The method of claim 10, further comprising determining if a correct tension is applied to the tether based on whether the tether is a flexible tether or a rigid tether.

12. The method of claim 11, wherein the correct tension is determined to be present when at least one of the following occurs: a) a measured tension is above a predetermined tension threshold, b) the measured tension is within a given a predetermined tension threshold range, and c) the measured tension for both lower anchor sensors is applied within a predetermined short duration time window if loading characteristics on the lower anchor sensors indicate that rigid straps are present.

13. The method of claim 10, further comprising sensing a seatbelt payout length and comparing the seatbelt payout length to a first seatbelt payout length threshold.

14. The method of claim 10, further comprising issuing a message when the seatbelt is not buckled, the child safety system is provisionally detected in the passenger seat, and the strap is not connected to at least one of the lower anchors.

15. The method of claim 10, further comprising issuing a message when the seatbelt is not buckled, the child safety system is provisionally detected in the passenger seat, the tether is connected to the upper anchor, and the strap is not connected to at least one of the lower anchors.

16. The method of claim 10, further comprising issuing a message when the seatbelt is not buckled, the child safety system is provisionally detected in the passenger seat, the strap is connected to the lower anchors, and the tether is not connected to the upper anchor.

17. The method of claim 10, further comprising issuing a message when the seatbelt is buckled, the child safety system is provisionally detected in the passenger seat, and the tether is not connected to the upper anchor.

18. The method of claim 10, further comprising issuing at least one of a message and no action when the seatbelt is buckled, the child safety system is provisionally detected in the passenger seat, the strap is connected to both of the lower anchors, and the tether is connected to the upper anchor.

19. The method of claim 10, further comprising disabling deployment of at least one airbag when the child safety system is verified in the passenger seat.

20. (canceled)
